(19) United States
(12) Patent Application Publication
(10) Pub. No.: US 2012/0292802 A1
(43) Pub. Date: Nov. 22, 2012

(54) EFFECTIVE MOLDING METHOD WITH A LIQUID CONDUCTOR

(76) Inventor: I-Jan Bill FANG, Kaohsiung (TW)

(21) Appl. No.: 13/110,905

(22) Filed: May 18, 2011

(51) Int. Cl. B29C 51/46; B29C 51/42

(52) U.S. Cl. 264/40.6; 264/319

(57) ABSTRACT

The present invention provides a molding method with a liquid heat conductor. Molding material is first input into a template and the filled template is then disposed over a conveyer above a driving chain wheel to be carried into a tank containing liquids as a heat conductor. The liquid inside the tank is water or oil.

### BACKGROUND OF THE INVENTION

1. Field of the Invention

The present invention relates to a molding method, and more especially, to a molding method using liquids as a heat conductor.

2. Description of Prior Art

In the conventional technology of molding, as shown in FIG. 1, the steps include: inputting molding materials into the template for molding; then, dispose the filled template onto the belt conveyer 1′; next, the template passes through a heating channel heated by electrical bars or air heater 2′ for material to be melt to fill up the molding template.

In the above-mentioned molding procedures, it is the ambient air around the template, which is then disposed on the conveyer belt 1′, that serves as a medium for heat to conduct to the molding template. Due to the effect of temperature gradient, which takes place from a region of higher temperature to a region of lower temperature and functions to equalize temperature differences (in gases and liquids, conduction is contributed by collision and diffusion of the molecules during their random motion), unevenly distributed hot air around the template adversely effects the otherwise homogeneous heating process during manufacturing, causing undesired folding or wrinkles over the surface of the integrated products and hence reducing the desired quality of products thus made.

Furthermore, due to the low specific heat inherent of air, the heat produced by the electric heater or hot-air blower tends to dissipate through the air, causing thermal energy to drop quickly, which in turn consumes more electricity and hence raising the manufacturing cost in production.

### OBJECTS AND SUMMARY OF THE INVENTION

It is therefore the main object of the present invention to provide an energy-saving molding method, during which the heat is conducted evenly to maintain a near-constant temperature to reduce product defective rates and, at the same time, to save energy.

To archive the above-mentioned goal, the technical solution provided by the present invention is to use liquids as the heat conduction medium during the heating process of the template.

The liquid used in the heating process as a medium for heat conduction can be either oil or water.

The detailed steps are described as follows:

1) inputting the raw material for the products to a molding template;

2) disposing the filled molding template onto a belt conveyer; next,

3) having the conveyer belt carry the template into a water tank filled with heated water of a pre-determined constant temperature for heating, and

4) after a specific time period, the template is taken out of the heated water tank for cooling.

Based on the above-mentioned description, an energy-saving molding method applies apparatus comprised of a driving chain wheel, a driven chain wheel, a belt conveyer, a water tank and a framework with two ends; the driving and driven chain wheels are separately mounted on the two ends of the framework; the belt conveyer is disposed over both the driving chain wheel and the driven chain wheel for the former (i.e. the driving chain wheel) activates and rotates the latter (i.e. the driven chain wheel) via the belt conveyer; the water tank is mounted on the framework about halfway of the belt conveyer between the two chain wheels while a part of the belt conveyer is completely merged inside the water tank.

The water tank is also attached with a thermostat for maintaining the tank at a desired constant temperature.

To be patentably distinguished from prior arts, the present invention replaces air with liquids, such as oil or water, as a heat conducting medium. Since water has a higher specific heat than air, water can be heated in a short time; similarly, the temperature of water does not drop quickly, thereby the hot-water tank is a better candidate than air for maintaining a near-constant temperature with a thermostat installed in the water tank. The loaded molding template being filled up with materials is merged completely within the hot-water tank, and is surrounded by hot water, which is able to maintain a near-constant temperature for the materials inside the template to be homogeneously heated in the process of forming into a fixed shape, while uneven surface over the products due to temperature differences during the shaping process is thus less likely to occur.

### BRIEF DESCRIPTION OF THE DRAWINGS

FIG. 1 is a solid view showing the apparatuses of the present invention.

FIG. 2 is a top-side view showing the apparatuses of the present invention.

FIG. 3 is a front-side view showing the apparatuses of the present invention.

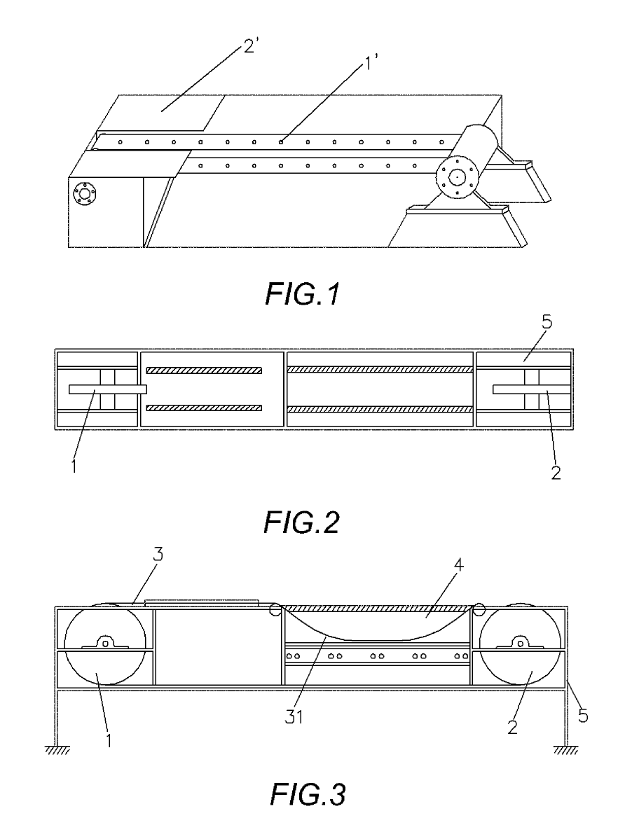

### DETAILED DESCRIPTION OF PREFERRED EMBODIMENTS

The present invention provides an energy-saving molding method for forming integrated products, in which the template filled with materials to be treated with heat is disposed on a conveyer to be carried into a water tank filled with heated water of a pre-set desired constant temperature. After a preset period of time, the material inside of the template will be formed into the desired shape and become solid; the template is then carried out of the tank.

The water tank 4 is mounted on the framework 5 around halfway of the belt conveyer 3 between the two chain wheels 1 and 2 so that a section 31 of the belt conveyer 3 is merged inside of the water tank 4, and the loaded template previously disposed on the belt conveyer 3 is thus carried into the water tank 4. For controlling the molding template at a near-constant temperature, water tank is optionally attached with a thermostat (not shown in drawings). The patentably distinguishing features of the present invention include, among others, liquids, instead of gases in conventional arts, used for heat conduction, which can be either oil or water, depending on evaporation of the liquid that the heating process allows. In a preferred embodiment of the current invention, water is elected as a heat conductor.

I claim:

1. A molding method with a liquid conductor, including steps of
i) inputting material into a molding template, and
ii) having said molding template heated by said liquid conductor containing a liquid.

2. The molding method with a liquid conductor as claimed in claim 1, wherein said liquid is oil.

3. The molding method with a liquid conductor as claimed in claim 1, wherein said liquid is water.

4. The molding method with a liquid conductor as claimed in claim 1, wherein said molding template is disposed onto a conveyer for being heated inside said liquid conductor, and is moved out of said liquid conductor after said material is hardened into shape.

5. The molding method with a liquid conductor as claimed in claim 1, wherein said conveyer is disposed between a driving chain wheel and a driven chain wheel, a section of said conveyer is merged into said liquid conductor and said molding template is disposed over said conveyer above said driving chain wheel to be carried into said liquid conductor.

6. The molding method with a liquid conductor as claimed in claim 1, wherein said liquid conductor is attached with a thermostat for controlling temperature.
